(19) United States
(12) Patent Application Publication
(10) Pub. No.: US 2014/0278906 A1
(43) Pub. Date: Sep. 18, 2014

(54) COUPON SYSTEM

(71) Applicant: Tech Fusion Corporation, Huntington Beach, CA (US)

(72) Inventors: William Sullivan, Huntington Beach, CA (US); Dennis Au, Torrance, CA (US); Chris Corbett, Rancho Santa Margarita, CA (US); Dale Hachiya, Huntington Beach, CA (US); Sean LeMons, Stanton, CA (US)

(21) Appl. No.: 13/927,882

(22) Filed: Jun. 26, 2013

Related U.S. Application Data
(60) Provisional application No. 61/802,032, filed on Mar. 15, 2013.

(51) Int. Cl. G06Q 30/02

(52) U.S. Cl. CPC G06Q 30/0238
USPC 705/14.38; 705/14.1

(57) ABSTRACT

A coupon system has a central computer, an ad placement program operably installed on the central computer, and a master coupon program operably installed on the central computer. The ad placement program receives the coupons from the promoters via the network, associates each of the coupons with at least one UPC identifying the product(s), and determines a price for placement of and/or use of each of the coupons in association with the at least one UPC. The master coupon program transmits the coupons to the users with reference to a selected UPC received from a user.

### CROSS-REFERENCE TO RELATED APPLICATIONS

This application for a utility patent claims the benefit of U.S. Provisional Application No. 61/802,032, filed Mar. 15, 2013.

### STATEMENT REGARDING FEDERALLY SPONSORED RESEARCH

Not Applicable

### BACKGROUND OF THE INVENTION

1. Field of the Invention

This invention relates generally to coupon systems, and more particularly to a coupon system that enables placement of coupons associated with a product.

2. Description of Related Art

Various patents and patent applications teach similar coupon delivery and redemption systems. Examples of such patents and applications include the following:

Sloan, U.S. Pat. No. 5,918,211, teaches a scanner device that is provided to shoppers, for scanning bar codes of products to receive special offers, coupons, etc., related to the product scanned. The specially designed device is in constant wireless communication with the store (and/or retailer/manufacturer computers). The scanner may also receive information about a loyalty program, so that the shopper's history may be used to offer additional coupons that might be available at that time.

Elhaoussine et al., U.S. 2003/0004808, teaches a coupon system that utilizes a mobile phone to scan a product for selecting suitable coupons. The selected coupons are stored in the mobile phone, and then transmitted to a payment terminal via an operable wireless connection, such as Bluetooth®. A list of products purchased is compared with the list of coupons to confirm that the necessary products were purchased, to then enable deduction of the coupon amounts.

Shaer, U.S. 2010/0268592, teaches a coupon system that also utilizes a mobile phone to scan a product to retrieve a coupon or other promotional, which is stored in a phone database. The system also teaches sending an alert to the mobile phone alerting the user to a promotion for a related product, which is stored in the phone for later communication to the payment terminal. The phone may communicate with the payment terminal with a wired connection, a wireless connection, or by generating bar codes for the coupons, which may be scanned in the same way paper coupons are scanned.

Other similar systems have been described in other recent patent applications, including: Ow, U.S. 2012/0303440, Head, U.S. 2008/0010114, and Pearlman, U.S. 2003/0233276. All of the above-described references are hereby incorporated by reference in full.

The prior art teaches various forms of coupon delivery and/or redemption systems. However, the prior art does not teach a coupon system that enables placement of a variety of related coupons associated with a product. The present invention fulfills these needs and provides further advantages as described in the following summary.

### SUMMARY OF THE INVENTION

The present invention teaches certain benefits in construction and use which give rise to the objectives described below.

The present invention provides a coupon system for receiving coupons for products from promoters via a network, offering the coupons to users via the network, and transmitting the coupons to a store computer upon checkout. The coupon system includes a central computer having a computer processor and a computer memory; an ad placement program operably installed on the computer memory of the central computer; and a master coupon program operably installed on the computer memory of the central computer.

In one embodiment, the ad placement program receives the coupons from the promoters via the network; associates each of the coupons with at least one UPC identifying the product(s); and determines a price for placement of and/or use of each of the coupons in association with the at least one UPC.

In one embodiment, a master coupon database may be operably installed on the computer memory of the central computer for storing the coupons and associating each of the coupons with the at least one UPC. The master coupon program transmits the coupons to the users using the following operations: receiving a selected UPC from one of the users; locating the selected UPC in the master coupon database; and transmitting the coupon(s) associated with the selected UPC to the user and/or the store computer.

A primary objective of the present invention is to provide a coupon system having advantages not taught by the prior art.

Another objective is to provide a coupon system that enables placement of coupons associated with a product in a manner that is easy for a user to review the coupons and make selections at the time of purchase, and then quickly and easily use the coupons.

Another objective is to provide a coupon system that enables placement of a additional coupons that are related to the product, for competing products, and/or products that are related to the product selected by the user.

A further objective is to provide a coupon system that can integrate with loyalty programs already offered by stores, that is easy to use, and that does not require a user to utilize a specialty electronic device.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of a portable electronic device having a shopper app installed thereupon for scanning a product, according to one embodiment of the present invention;

FIG. 2 is a block diagram of the operable components of the portable electronic device of FIG. 1;

FIG. 3 is a block diagram of a coupon system that includes the portable electronic device of FIGS. 1 and 2, used in conjunction with a central computer having a master coupon program, and a store computer that includes a POS computer having a scanner;

FIG. 4 is a flow diagram of a method of receiving a coupon from a manufacturer at a given price per click or impression;

FIG. 5 is a flow diagram illustrating the operation of the coupon system to display available coupons to the user via the master coupon program and the shopper app;

FIG. 6 is a flow diagram illustrating the transmittal of selected coupons from the user during checkout;

FIG. 7 is a front elevational view of a portable electronic device generating a bar code to transmit one of the selected coupons to the POS computer of FIG. 3;

FIG. 8 is a front elevational view of the portable electronic device generating a QR code to transmit all of the selected coupons to the POS computer; and

FIG. 9 is a perspective view of a portable electronic device, illustrating a graphic user interface generated by the shopper app for displaying in-store specials.

### DETAILED DESCRIPTION OF THE INVENTION

The above-described drawing figures illustrate the invention, a coupon system 10 and method for receiving coupons for products 12 from promoters via a network 16, distributing the coupons to users via the network 16, and redeeming the coupons at checkout. The coupon system 10 delivers the coupons to a computer device of the user, typically a portable electronic device 20 such as a smart phone, tablet computer, or similar electronic device, although alternative devices may be used in alternative embodiments of the invention.

FIG. 1 is a perspective view of one embodiment of the portable electronic device 20 being utilized with the coupon system 10. FIG. 2 is a block diagram of the operable components of the portable electronic device 20 of FIG. 1. As illustrated in FIGS. 1-2, the portable electronic device 20 of this embodiment is a smart phone that includes a shopper app 26 installed thereupon. The shopper app 26, or “application,” is a program that may be downloaded and installed using methods known in the art. The shopper app 26 enables the user to select a product 12, as illustrated in FIG. 1, and to communicate with the coupon system 10 as described in greater detail below to find coupons for the product 12, or related products.

As illustrated in FIG. 2, the portable electronic device 20 may include various electronic components known in the art for this type of device. In this embodiment, the portable electronic device 20 may include a computer processor 22, a computer memory 24, a display 32, RAM 34, an NFC interface 36, a camera 38, a user input device 40 (e.g., touch screen, keyboard, and/or other form of input device known in the art), and a transceiver 42 for wireless communication. For purposes of this application, the term “transceiver” is defined to include any form of transmitter and/or receiver known in the art, for cellular, WIFI, radio, and/or other form of wireless communication known in the art. A global positioning system (“GPS”) 48 may also be included, as is known in the art of these types of portable electronic devices 20. Obviously, these elements may vary, or may include alternatives known in the art, and such alternative embodiments should be considered within the scope of the claimed invention.

As illustrated in FIG. 2, the computer memory 24 of the portable electronic device 20 may be used to download software applications, or “apps,” to extend the utility of the portable electronic device 20. In this case, the computer memory 24 of the portable electronic device 20 receives the shopper app 26 and/or a browser app 28 for browsing web pages that may include additional coupon options. A local database 30 may be included for receiving and storing data temporarily, such as selected coupons, and information about the user; however, this is not required, and all data may be retained in another location if desired. Additional programs may also be included, including but not limited to a bar code sequential display program 44 and/or a QR generator program 46, both of which are discussed in greater detail below.

In the embodiment of FIGS. 1 and 2, the shopper app 26 of FIG. 2 may be used to generate a graphic user interface 60 on the display 32 of the portable electronic device 20, as illustrated in FIG. 1, to enable the user to interact with the shopper app 26. In this embodiment, the graphic user interface 60 may be used to select a product identifier of the product 12 that the user is interested in purchasing, to determine if there are any related coupons. For purposes of this application, the selection of the product identifier includes the selection of at least one or more product identifier(s), and any number may be selected using any methods known in the art.

In the present embodiment, the graphic user interface 60 include a scan button 62. When the user presses the scan button 62, the camera 38 is used to capture an image of a bar code 14 of the product 12. This image is then used to determine the product identifier of the product 12, in this case a universal product code (“UPC”) of the product 12. In alternative embodiments, the product identifier of the product 12 may be entered or determined using any techniques known in the art, such as manually typing in the UPC, a description of the product 12, or by selecting a product 12 from menu options (via a search button 64 in the illustrated embodiment). In another embodiment, speech recognition may be used, or other methods known in the art. The terms “universal product code” and “UPC” are hereby defined to include any equivalent identification system or code that may be utilized to identify the product 12.

The graphic user interface 60 may also include a cart button 66, and an in-store special button 68, both of which are described in greater detail below. The in-store special button 68 may be used to access a list of in-store specials, as discussed below. The graphic user interface 60 may also provide coupons, in text and/or graphic form, as discussed below, for selection by the user.

The shopper app 26 of FIG. 2 enables communication with a central computer 70 (illustrated in FIG. 3) to receive available coupons for or related to the product 12 selected. In this embodiment, the display 32 may be used for offering the available coupons to the user. In the illustrated embodiment, the display 32 shows a first coupon 50 for the product 12, a second coupon 52 for the product 12 and a second product, a third coupon 54 for a competing brand of the product, and additional coupons 56 for related products (in this case, other varieties of cereals). For purposes of this application, the term “coupon” includes the terms of any form of discount, promotion, or special offer, such as are known in the art. The coupon may be a digital coupon that includes a certain discount for every item purchased, and may include a term (e.g., having an expiration date), and/or other requirements for redemption (e.g., purchasing a certain quantity of the product).

A “more coupons” button 58 may be included to allow the user to page through additional options (or alternatively, a scroll function, not shown, could be used, or other equivalent functions known in the art). Merely pressing on one of these buttons enables the user to select a coupon that he or she would like to use. Upon checkout, as described below, the user will receive the discount from the selected coupon.

In the present embodiment, the coupon may further include a graphic image 60 of the product 12 or a related product, a logo related to the product, or other graphic design element to draw attention to the associated coupon. The graphic image 60 is one type of option that might be offered for a higher placement price, as discussed below in greater detail. While one embodiment of the shopper app 26 is illustrated herein, those skilled in the art will recognize that alternative systems and methods may be used consistent with the teachings of this invention, and such alternatives should be considered within the scope of the present invention.

FIG. 3 is a block diagram of the coupon system 10 that includes the portable electronic device 20 of FIGS. 1 and 2, used in conjunction with a central computer 70. The coupon system 10 may interact, in some embodiments, with a manufacturer computer 80 to receiving coupons for placement. The coupon system may also interact with a store computer 90, so that the coupon system 10 can interact with a POS computer 100 during checkout. These options are discussed in greater detail below.

As illustrated in FIG. 3, the central computer 70 includes a computer processor 72 and a computer memory 74, such as is well known in the art. As used throughout this application, the terms computer, computer processor, computer memory, and other computer related components, are hereby expressly defined to include any arrangement of computer(s), processor(s), memory device or devices, and/or computer components, either as a single unit or operably connected and/or networked across multiple computers (or distributed computer components), to perform the functions described herein. Those skilled in the art will recognize that different functions may be performed on physically different computers, or all on a single computer, and the various components may be present in different numbers and different forms, and all such alternative arrangements known in the art should be considered within the scope of the present invention.

As illustrated in FIG. 3, an ad placement program 75 may be operably installed in the computer memory 74 of the central computer 70, and enables manufacturers to arrange placement of coupons in the coupon system 10. For purposes of this application, the term “manufacturer” is defined to include any business or entity that might want to place coupons on the system, whether they are manufactures of the products, distributers of the products, marketing companies, or any other business or entity that wants to promote the sales of the products. While a single program is illustrated on a single computer, as noted above, the program may be broken into multiple components installed on different computers, and this alternative is expressly considered within the definition of the terms as discussed above. The operation of one embodiment of the ad placement program 75 is illustrated in FIG. 4, and discussed in greater detail below.

As illustrated in FIG. 3, a master coupon program 76 is operably installed in the computer memory 74 of the central computer 70, and controls the operation of the coupon system 10. The master coupon program 76 may function in conjunction with a master coupon database 77, which functions to store the necessary data, and associate the data as discussed herein. While a single program is illustrated on a single computer, as noted above, the program may be broken into multiple components installed on different computers, and this alternative is expressly considered within the definition of the terms as discussed above. The operation of one embodiment of the master coupon program 76 is illustrated in FIG. 5, and discussed in greater detail below.

The portable electronic devices 20 of FIGS. 1-2 may operably communicate with the central computer 70 via the network 16, as illustrated in FIG. 3. While any form of network may be used, in this embodiment the network 16 includes a cell tower 78 or similar network device 79 that may operably communicate with the rest of the network (e.g., the Internet, a private network, or other similar or equivalent network).

A manufacturer computer 80 (similarly having a computer processor 82 and a computer memory 84) may similarly enter into such communication with the central computer 70 via the network 16, using any systems and methods known in the art, for creating coupons, as illustrated in FIG. 4 and discussed below. Since this operative communication is well known in the art, it is not described in greater detail herein.

The manufacturer computer 80 may be used by the manufacturer to access the computer system 10 for adding coupons and otherwise participating and interacting with the system 10, as discussed in more detail herein. The manufacturer computer 80 may also include downloaded programs (apps) for various types of interaction with the system 10. For example, the manufacturer computer 80 may include a daily special program 86 that may be used to create and maintain a daily special on the system 10.

The daily special may include a special minimum coupon offer that is always available for a range of products (e.g., all KRAFT® products, all of a certain type of product, etc.). These general coupon offers may be subject to certain minimums or other standards and/or limitations, and may be offered to only certain target demographics, or to all consumers.

These minimum coupon offers may be automatically downloaded to all portable electronic devices 20, and may thus be made always available, regardless of the availability of special offers, and even available for use if there is no network connectivity at the time of purchase. This gives the customer a guaranteed benefit at all times, and thus provides an inventive to always use the coupon system 10, because the consumer will know that a certain minimum benefit will always be available. In case of loss of connectivity with the primary network (e.g., cell phone network, or other), the system 10 may also switch to the use of WiFi or similar local network, to maintain connectivity, even the use of a store WiFi network, or other suitable network.

In the embodiment of FIGS. 1-3, the daily special program 86 interacts with the master coupon program 76, both illustrated in FIG. 3, to download the daily special to the shopper app 26 (of FIG. 2) of the portable electronic devices 20 (of FIG. 3) This daily special may be stored in the local database 30 (of FIG. 2) for extended periods of time, so that a data connection is not required to display this offer to the user.

The shopper app 26 may also function to generate a banner advertisement (not shown) on the display 32 that advertises any forms of coupons, promotions, advertisements, and/or any other information that might be of interest to the users of the system, including but not limited to special rewards point for use of the coupon system 10, randomly generated special coupons, and other similar rewards that encourage the frequent use of the coupon system 10 by the user. Furthermore, it may include a “time of day” coupon that provides a special reward for purchases made at a certain day and/or time of day. Such coupons may be offered by a store, for example, to encourage traffic during slow days and/or times of day, and moderate traffic during peak times. The banner ad of this embodiment displays a coupon that is good only on purchases made during a predetermined time of day.

A store computer 90, having a computer processor 92 and a computer memory 94, may also be connected via the network 16 with the central computer 70, for purposes described in greater detail below. As discussed below, the store computer 90 may include a loyalty rewards program 96 that interacts with the master coupon program 76, for offering special coupons to loyal customers via the coupon system 10, and for providing demographic information about the users of the coupon system 10. The store computer 90 may further include a customer database 98 for tracking the customers in the loyalty program, and a coupon database 99 to track the coupons being offered to the various customers, either using or not using the loyalty program.

As discussed in greater detail below, the store computer 90 will typically have one or more POS computers 100 operatively connected with the store computer 90 for checking out customers of the store. The POS computers 100 may interact with the coupon system 10 in various ways as discussed below. The POS computers 100 each include a computer processor 102 and a computer memory 104. A checkout program 106 may be operatively installed in the computer memory 104 for the store checkout process, and may include a fairly standard program known in the art. The checkout program 106 typically is operatively engaged with a scanner 108 for scanning products, coupons, and the like, during the checkout process. The interaction of these systems with the coupon system 10 is discussed in greater detail below.

The store computer 90, or other suitable network connection, may be used to participate in the coupon system 10 directly, to interact with the system 10 for upload and download of coupons, and to designate in-store specials, as described in greater detail below with reference to FIG. 9. While certain forms of interaction are described herein, this list is not intended to be exhaustive, but merely illustrative of the potential options made possible by the system 10.

FIG. 4 is a flow diagram of a method of receiving the coupon from a promoter using the ad placement program 75. The promoter may access the coupon system 10 using any method known in the art, in this case from the manufacturer computer 80 illustrated in FIG. 3. The manufacturer computer 80 may be a personal computer, any other form of computer device, smart phone, tablet computer, phone system, or other form of communication network, including through intermediaries such as call center operators, or other methods). The coupon is received for placement in the coupon system 10 at a given price per click or impression (or other method of determining payment known in the art), as described in greater detail below, and illustrated in FIG. 4.

In the embodiment of FIG. 4, the promoter uses the manufacturer computer 80 to select a product via the product identifier (e.g., by name, selection from a list, scanning a bar code, or any other method known in the art). The identification of the product, such as with reference to the UPC, is then transmitted to the ad placement program 75 of the central computer 70 (of FIG. 3), for association with the coupon that was uploaded. In some embodiments, multiple product identifiers may be associated with a given coupon.

As illustrated in FIG. 4, the ad placement program 75 functions to receive the request from the promoter and the UPC, and find the UPC in the master coupon database 77 to determine a price associated with the product identified with the UPC. The price may be determined in any manner known in the art. For example, the prices may be set by the operator of the coupon network 10, they may be determined in an auction format, special deals may be negotiated directly with a given promoter, or another method may be used. The price may be determined based upon the retail price of the product, the demand for this particular product, demand from other promoters for placing coupons in association with this product, and/or other factors.

The price may be based on impressions delivered by the coupon system 10, by actual coupon selections, or other systems and methods, as desired by the operator of the coupon system 10. The price (per click, or per impression, or other) is transmitted to the promoter, who is then able to accept or reject the offer.

If accepted, the promoter is then prompted to create or otherwise enter (or upload) the coupon (including the terms of the coupon, expiration date, etc.). The coupon is received and stored in a database, such as the master coupon database 77 described above, and associated with the product (e.g., product identifier). When this product is selected by future shoppers, they may be offered the coupon, along with any other competing coupons, for the shopper to review and potentially select.

Obviously, more powerful systems may offer additional options to enable the promoter to more closely control the offerings being made. A given coupon may be offered only in certain stores, certain geographic areas, or to shoppers who meet certain demographic requirements. These any other more powerful options are considered within the scope of the present invention.

FIG. 5 is a flow diagram illustrating the operation of the coupon system 10 to transmit the coupons to the user via the master coupon program 76 and to display the coupons to the user via the shopper app 26. The master coupon program 76 and the shopper app 26 together function to receive data from the portable electronic device 20 of the user (in practice, many users), return the coupons that are suitable for the user, and enable the user to select his or her preferred coupons.

The master coupon program 76 may function to transmit the coupons to the users using the following operations:
i) receiving a selected product identifier (e.g., UPC) from one of the users;
ii) transmitting the coupons associated with the UPC to the user;
iii) receiving a selected coupon from the user;
iv) processing the coupon to provide a discount to the user; and
v) tracking the payment due following the placement of and/or use of each of the coupons, per the price determine in the ad placement program 75, in response to user viewing and/or use of the coupons.

As illustrated in FIG. 5, in this embodiment the user must first download and run the shopper app 26 from the portable electronic device 20 of FIG. 1. The download, installation, and operation of such “apps”, or equivalent systems, utilizes systems and methods that are well known in the art, and are therefore not described in greater detail herein. In alternative embodiments, the user might access the central computer 70 from alternative systems (e.g., a PC, kiosk, etc.), and such alternatives are considered within the scope of the present invention.

In the embodiment of FIG. 5, the user may first identify the store at which he or she will be shopping. This can be determined by a GPS 48 (“global positioning system” shown in FIG. 2) when the shopper is physically located in the store, or by a manual selection process, or any other method known in the art. In some embodiments, this step may not be required, or the store determination may be made in other ways, such as during checkout.

While the user is shopping, he or she may scan a bar code 14 of the product 12 of interest (e.g., via an image capture process using the camera 38 of the mobile electronic device, shown in FIG. 2), to determine a UPC for the product 12. Other methods may also be used, including manually entering the UPC number, or manually selecting the product 12 from a list, or any other method known to those skilled in the art.

As illustrated in FIG. 5, with reference to the computer system 10 of FIG. 3, the UPC is then transmitted to the central computer 70 (of FIG. 3), where it is received by the master coupon program 76, and the UPC is processed to determine if there are any coupons in the master coupon database 77 that are associated with that product 12. Any available coupons that are located are then transmitted to the user, where they are displayed for review by the user (e.g., on the display 32 of the mobile electronic device of FIGS. 1-2). While one embodiment of this display 32 is illustrated in FIG. 1, those skilled in the art may devise many alternative methods of displaying the coupons, and such alternative methods should be considered within the scope of the present invention.

The user is then able to select a selected coupon from the list, and add the selected coupon to a shopping cart, or otherwise select the coupon for use. The selected coupon may then be stored in the local database 30 of the mobile electronic device (illustrated in FIG. 2), and/or transmitted to the central computer 70 for storage in the master coupon database 77. The user is then able to continue shopping and selecting new products to scan, or he or she can proceed to checkout.

FIG. 6 is a flow diagram illustrating the transmittal of the selected coupons from the user to the POS computer 100 (illustrated in FIG. 3) during checkout. As illustrated in FIGS. 1-3, and 6, when the store is participating member of the coupon system 10, the POS computer 100 is adapted to communicate with the central computer 70, typically through the store computer 90, so that the selected coupons stored in the master coupon database 77 can be sent directly to the store computer 90 for checkout processing. In this embodiment, the user presses the cart button 66 on the portable electronic device 20, as illustrated in FIG. 1, to start the checkout procedure. At that time, he or she also gives his or her loyalty ID to the cashier operating the POS computer 100 (of FIG. 3). The cashier enters the loyalty ID (typically a phone number), or scans a loyalty card (or some equivalent method of communicating the loyalty ID), and this enables the POS computer 100 to receive the selected coupons directly from the central computer 70, and associate them with the correct customer.

If the store does not participate in the coupon system 10, alternative methods are used to transmit the selected coupons from the local database 30 of the portable electronic device 20 to the POS computer 100 (or the store computer). In one embodiment, the portable electronic device 20 directly communicates with the POS computer 100, via wireless (e.g., Bluetooth®, or similar protocol), or via the NFC interface 36. In another embodiment, the portable electronic device 20 generates bar codes or similar visual indicia that can be scanned with the scanner 108 of the POS computer 100. Two specific embodiments of this approach are discussed below with reference to FIGS. 7 and 8.

FIG. 7 is a front elevational view of a portable electronic device 20 generating a bar code 110 to transmit at least one of the selected coupons to the POS computer 100 (of FIG. 3). In one embodiment, illustrated in FIGS. 1-3 and 7, the portable electronic device 20 further includes a bar code sequential display program 44 operably installed on the computer memory 24 of the portable electronic device 20 that functions to sequentially generate a series of bar codes 110 so that the portable electronic device 20 can be held over the scanner 108 and scan a series of bar codes 110 in one single process. In this embodiment, the portable electronic device 20 generates a “start” button 112 that starts the process, with enough time between each display to allow the scanner 108 to register each of the bar codes 110. This sequential process saves time during the checkout process, so that the POS computer 100 is not occupied to the delay of other shoppers.

FIG. 8 is a front elevational view of the portable electronic device 20 generating a QR code 114 to transmit all of the selected coupons to the POS computer 100. In this embodiment, as illustrated in FIGS. 1-3 and 8, the portable electronic device 20 includes a QR generator program 46 operably installed on the computer memory 24 of the portable electronic device 20 (of FIG. 2). The QR generator program 46 creates a QR code 114 that includes all of the selected coupons in one code, which can then be displayed on the display 32 of the portable electronic device 20 and scanned by the scanner 108 of the POS computer 100 to transfer the selected coupons to the POS computer 100 in one process.

FIG. 9 is a perspective view of the portable electronic device, illustrating a graphic user interface 120 generated by the shopper app 26 for displaying in-store specials 122. As illustrated in FIG. 9, the in-store specials 122 advertise special in-store advertising determined by a store, such as top sales items, and/or a list of daily specials and/or any other form of special offer being offered by the store and/or one or more manufacturers. This gives individual stores the opportunity to publicize special items that they would like to discount for quick movement (e.g., perishable items that do not have much shelf life left, etc.). The in-store specials 122 may also include any other form of promotion that a store manager (or other store management and employees) might want to run. The in-store specials 122 may also offer in-store advertising as part of a loyalty program, or other similar program.

Similarly, the in-store specials 122 (or other suitable section of the display 32) may also include special rewards points, randomly generated special coupons, and other similar rewards that encourage the use of the store's loyalty program by the user.

### Method of Use

The invention also include a method of using the coupon system 10, as described above, for receiving coupons for products from promoters via the network, and offering the coupons to users via the network. In this method, the coupons are received by the central computer 70 from the promoters via the network, and the coupons are associated with at least one UPC of the associated product. The coupons are stored in the computer memory of the central computer 70 associated with the at least one UPC. These steps are discussed in greater detail above. In addition to the system described above, additional coupons may also be added from outside databases of available coupons, as well as loyalty program coupons. As used in the present application, the term “coupon” is broadly defined to include any form of coupon, promotion, discount, rebate, and/or similar or equivalent program.

Once the coupons are in the computer memory of the central computer 70, a selected UPC is received from one of the users. The coupons associated with the selected UPC are transmitted to the user, and the user is able to select a selected coupon which is saved to a local database 30 of the portable electronic device 20 and/or to the master coupon database 77 of the central computer 70.

As discussed above, the selected coupons are transmitted from either the local database 30 or the master coupon database 77 to the POS computer 100, at which time the coupon is processed to provide a discount to the user, and payments are made from the coupon issuer to all interested parties, in a manner similar to the prior art coupon systems. Furthermore, a payment due is determined in response to the placement of and/or use of each of the coupons in response to user viewing and/or use of the coupons.

As used in this application, the words “a,” “an,” and “one” are defined to include one or more of the referenced item unless specifically stated otherwise. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application.

What is claimed is:

1. A coupon system for receiving coupons for products from promoters via a network and associating each of the coupons with a price for placement of that coupon with a user, the coupon system comprising:
a central computer having a computer processor and a computer memory;
an ad placement program operably installed on the computer memory of the central computer for performing the following operations:
i) receiving the coupons from the promoters via the network;
ii) associating each of the coupons with at least one UPC identifying the product(s); and
iii) determining the price for placement of and/or use of each of the coupons in association with the at least one UPC; and
a master coupon database operably installed on the computer memory of the central computer for storing the coupons and associating each of the coupons with the at least one UPC and with the price for placement determined by the ad placement program.

2. The coupon system of claim 1, further comprising:
a master coupon program operably installed on the computer memory of the central computer for transmitting the coupons to the users using the following operations:
i) receiving a selected UPC from one of the users;
ii) locating the selected UPC in the master coupon database; and
iii) transmitting the coupon(s) associated with the selected UPC to the user and/or the POS computer.

3. The coupon system of claim 2, wherein the master coupon program functions to transmit the selected coupons from the master coupon database of the central computer to a portable electronic device of the user, the portable electronic device having a computer processor and a computer memory, and further comprising a bar code sequential display program operably installed in the computer memory of the portable electronic device, that functions to display bar codes on a display of the portable electronic device so that the bar codes may be scanned to transfer the selected coupons to a POS computer.

4. The coupon system of claim 1, wherein the master coupon program functions to transmit the selected coupons from the master coupon database of the central computer to a portable electronic device of the user, the portable electronic device having a computer processor and a computer memory, and further comprising a QR generator program operably installed in the computer memory of the portable electronic device, that functions to display a QR code on a display of the portable electronic device so that the bar codes may be scanned to transfer the selected coupons from the portable electronic device to a POS computer.

5. The coupon system of claim 1, further comprising a shopper app that is adapted to be downloaded to a portable electronic device.

6. The coupon system of claim 5, wherein the shopper app functions to receive coupons from the central computer and display the coupons on a display of the portable electronic device.

7. The coupon system of claim 6, wherein the shopper app further functions to enable the user to select one of the coupons on the display of the portable electronic device, and to transmit the selected coupon to the central computer.

8. A coupon system for receiving coupons for products from promoters via a network, offering the coupons to users via the network, and transmitting the coupons to a POS computer upon checkout, the coupon system comprising:
a central computer having a computer processor and a computer memory;
an ad placement program operably installed on the computer memory of the central computer for performing the following operations:
iv) receiving the coupons from the promoters via the network;
v) associating each of the coupons with at least one UPC identifying the product(s); and
vi) determining a price for placement of and/or use of each of the coupons in association with the at least one UPC;
a master coupon database operably installed on the computer memory of the central computer for storing the coupons and associating each of the coupons with the at least one UPC; and
a master coupon program operably installed on the computer memory of the central computer for transmitting the coupons to the users using the following operations:
iv) receiving a selected UPC from one of the users;
v) locating the selected UPC in the master coupon database; and
vi) transmitting the coupon(s) associated with the selected UPC to the user and/or the POS computer.

9. The coupon system of claim 8, wherein the master coupon program also tracks the payment due following the placement of and/or use of each of the coupons, per the price determined by the ad placement program.

10. The coupon system of claim 8, wherein the master coupon program functions to transmit the selected coupons from the master coupon database of the central computer to a portable electronic device of the user, the portable electronic device having a computer processor and a computer memory, and further comprising a bar code sequential display program operably installed in the computer memory of the portable electronic device, that functions to display bar codes on a display of the portable electronic device so that the bar codes may be scanned to transfer the selected coupons to a POS computer.

11. The coupon system of claim 8, wherein the master coupon program functions to transmit the selected coupons from the master coupon database of the central computer to a portable electronic device of the user, the portable electronic device having a computer processor and a computer memory, and further comprising a QR generator program operably installed in the computer memory of the portable electronic device, that functions to display a QR code on a display of the portable electronic device so that the bar codes may be scanned to transfer the selected coupons from the portable electronic device to a POS computer.

12. The coupon system of claim 8, further comprising a shopper app that is adapted to be downloaded to a portable electronic device.

13. The coupon system of claim 12, wherein the shopper app functions to receive coupons from the central computer and display the coupons on a display of the portable electronic device.

14. The coupon system of claim 13, wherein the shopper app further functions to enable the user to select one of the coupons on the display of the portable electronic device, and to transmit the selected coupon to the central computer.

15. The coupon system of claim 8, wherein the master coupon program transmits the coupon to a portable electronic device of a user for storage in a local database of the portable electronic device.

16. The coupon system of claim 15, wherein the portable electronic device includes a shopping app that displays the coupon on a display of the portable electronic device.

17. The coupon system of claim 16, wherein the shopping app generates a banner ad on the display of the portable electronic device, the banner ad displaying in-store advertising that includes a special offer on perishable food.

18. The coupon system of claim 16, wherein the shopping app generates a banner ad on the display of the portable electronic device, the banner ad displaying a random coupon generated as a reward for use of the coupon system.

19. The coupon system of claim 16, wherein the shopping app generates a banner ad on the display of the portable electronic device, the banner ad displaying a coupon that is good only on purchases made during a predetermined time of day.

20. A coupon system for receiving coupons for products from promoters via a network, offering the coupons to users via the network, transmitting the coupons to a portable electronic device of the user, which then functions to transmit the coupons to a POS computer upon checkout, the coupon system comprising:
a central computer having a computer processor and a computer memory;
an ad placement program operably installed on the computer memory of the central computer for performing the following operations:
i) receiving the coupons from the promoters via the network;
ii) associating each of the coupons with at least one UPC identifying the product(s); and
iii) determining a price for placement of and/or use of each of the coupons in association with the at least one UPC;
a master coupon database operably installed on the computer memory of the central computer for storing the coupons and associating each of the coupons with the at least one UPC;
a store app adapted to be installed on a portable electronic device of the user, the store app functioning for scanning the product to determine a UPC for the product, and for transmitting the UPC to the central computer; and
a master coupon program operably installed on the computer memory of the central computer for transmitting the coupons to the users using the following operations:
i) receiving a selected UPC from one of the users;
ii) locating the selected UPC in the master coupon database;
iii) transmitting the coupon(s) associated with the selected UPC to the POS computer, either directly or via the store app of the user; and
iv) tracking the payment due following the placement of and/or use of each of the coupons, per the price determined by the ad placement program.
